(19) United States
(12) Patent Application Publication
(10) Pub. No.: US 2019/0287318 A1
(43) Pub. Date: Sep. 19, 2019

(54) VEHICLE DATA MANAGEMENT SYSTEM AND VEHICLE DATA MANAGEMENT METHOD

(71) Applicant: HONDA MOTOR CO., LTD., Tokyo (JP)

(72) Inventors: Kichinosuke Fukuhara, Tokyo (JP); Kei Nakajima, Tokyo (JP)

(21) Appl. No.: 16/290,173

(22) Filed: Mar. 1, 2019

(30) Foreign Application Priority Data
Mar. 13, 2018 (JP) 2018-045215

(51) Int. Cl. G07C 5/00; G07C 5/08; H04L 29/06; H04W 4/44

(52) U.S. Cl. CPC G07C 5/008; H04W 4/44; H04L 63/0428; G07C 5/0841

(57) ABSTRACT

A car data management system is configured to include an on-vehicle terminal that transmits collected data collected from a car to a data server which transmits data encrypted in a decryptable manner, a user terminal, a demander terminal that inquires the user terminal about permission/non-permission for decryption of the encrypted collected data, and an ID management terminal that manages a decryption key for the collected data. When permission for decryption in response to the inquiry about permission/non-permission for decryption is inputted to the user terminal, the ID management terminal transmits the decryption key to the demander terminal.

### INCORPORATION BY REFERENCE

The present application claims priority under 35 U.S.C.§ 119 to Japanese Patent Application No. 2018-045215 filed on Mar. 13, 2018. The content of the application is incorporated herein by reference in its entirety.

### BACKGROUND OF THE INVENTION

### Field of the Invention

The present invention relates to a vehicle data management system and a vehicle data management method.

### Description of the Related Art

A technique has been known in which data for enabling specification of the car traveling state of a car is transmitted to a server, and the server analyzes the data, whereby searching for a car malfunction or a failure cause is facilitated (see Japanese Patent Laid-Open No. 2002-323409, for example).

Also, a technique has been known in which, in a system for providing data collected in a car to an external information terminal, when a PIN number held by the external information terminal matches a prescribed PIN number, the data is provided to the external information terminal from the car (see Japanese Patent Laid-Open No. 2004-196251, for example).

According to the technique of Japanese Patent Laid-Open No. 2004-196251, data of a car is provided only to an external information terminal that holds a PIN number.

However, when the number of provision destinations of car data is two or more, it is difficult for a user to get to know the provision destinations one by one so as to actively provide the data.

An object of the present invention is to provide a vehicle data management system and a vehicle data management method for allowing a user to actively provide data of a vehicle such as a car.

### SUMMARY OF THE INVENTION

An aspect of the present invention provides a vehicle data management system including

a transmission terminal that transmits vehicle data of a vehicle to a data server which transmits data encrypted in a decryptable manner,

a user terminal that can be operated by a user,

a demander terminal that inquires the user terminal about permission/non-permission for decryption of the vehicle data which is transmitted from the data server, and

a management terminal that manages decryption-use data for the vehicle data which is transmitted from the data server, wherein

when permission for decryption in response to the inquiry about permission/non-permission for decryption is inputted to the user terminal through operation performed by the user, the management terminal transmits the decryption-use data for the vehicle data to the demander terminal.

According to the aspect of the present invention, in the above vehicle data management system, the management terminal includes a transmission unit that transmits a signal for disabling decryption of the vehicle data to the demander terminal that has already received the decryption-use data for the vehicle data.

According to the aspect of the present invention, in the above vehicle data management system, the data server includes a list generation unit that generates a list of a data item included in the vehicle data.

According to the aspect of the present invention, in the above vehicle data management system, the vehicle is a car, and a data item included in the vehicle data includes at least one of a time, an on/off cycle number of an ignition key of the vehicle, fuel efficiency, power consumption, a remaining electrical amount, a vehicle speed, and vehicle position information.

According to the aspect of the present invention, in the above vehicle data management system, the data server provides decryption-use data different for each data item of the vehicle data.

According to the aspect of the present invention, in the above vehicle data management system, the vehicle is a car, and the vehicle data is generated by unit of on-to-off time period of an ignition key of the vehicle.

An aspect of the present invention is a vehicle data management method for a vehicle data management system that includes:

a transmission terminal that transmits vehicle data of a vehicle to a data server which transmits data encrypted in a decryptable manner;

a user terminal that can be operated by a user; and

a demander terminal that receives the decryptable vehicle data from the data server,

the method including

a step of causing a management terminal to manage decryption-use data for the vehicle data which is transmitted from the data server,

a step of causing the demander terminal to inquire the user terminal about permission/non-permission for decryption of the vehicle data which is received from the data server, and

a step of, when permission for decryption in response to the inquiry about permission/non-permission for decryption is inputted to the user terminal through operation performed by the user, transmitting the decryption-use data for the vehicle data from the management terminal to the demander terminal.

According to the aspect of the present invention, a user can actively provide vehicle data.

### BRIEF DESCRIPTION OF THE DRAWINGS

FIG. 1 is a diagram schematically illustrating the configuration of a car data management system according an embodiment of the present invention;

FIG. 2 is a diagram schematically illustrating the configuration of an on-vehicle system provided to a car, together with the functional configuration of an on-vehicle terminal;

FIG. 3 is a diagram illustrating the functional configuration of a user terminal;

FIG. 4 is a block diagram illustrating the functional configuration of a data server;

FIG. 5 is a diagram illustrating the functional configuration of an ID management terminal;

FIG. 6 is a sequence diagram showing operation of the car data management system during data collection of car data;

FIG. 7 is a sequence diagram showing operation of the car data management system when a demander uses collected data;

FIG. 8 is a diagram showing one example of a reply screen; and

FIG. 9 is a sequence diagram showing operation of the car data management system when a user cancels permission for provision of a data item.

### DETAILED DESCRIPTION OF THE REFERRED EMBODIMENTS

Hereinafter, an embodiment of the present invention will be described with reference to the drawings.

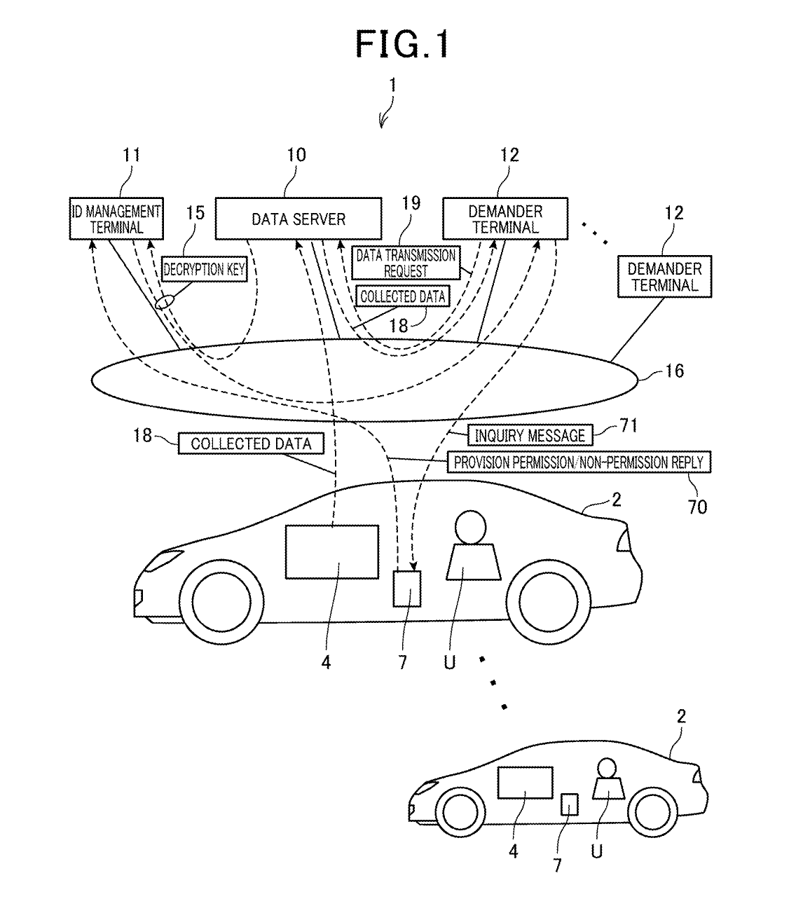

FIG. 1 is a diagram schematically illustrating the configuration of a car data management system 1 according the present embodiment.

The car data management system 1 includes an on-vehicle terminals 4 that is installed in each of cars 2, a user terminal 7 possessed by a user U, a data server 10, an ID management terminal 11, and a plurality of demander terminals 12, which are communicatively connected to an electric communication line 16. The electric communication line 16 includes a mobile communication network (e.g., a cellular phone network) for providing mobile communication, and the internet or the like for providing wide-area communication.

Each of the cars 2 is a car that travels with power from a prime motor such as an internal combustion engine, a hybrid engine, or an electric motor. In the present embodiment, the cars 2 are four-wheeled automobiles. However, the cars 2 may be other automobiles such as two-wheeled automobiles. Further, the cars 2 are not limited to automobiles, and railroad vehicle or the like may be used as the car 2.

The on-vehicle terminal 4 is an information processing apparatus installed in each of the cars 2, and is configured as an on-vehicle information collecting apparatus having a function of collecting various car data from the car 2. The on-vehicle terminal 4 transmits, as collected data 18, a group of collected car data to the data server 10 via the electric communication line 16.

The user terminal 7 is a terminal that is possessed by the user U and can be operated by the user U, and is a communication terminal capable of performing communication via the electric communication line 16. Specific examples of the user terminal 7 include a cellular phone, a smartphone, a mobile personal computer, a portable music player, and a smartwatch.

The data server 10 receives the collected data 18 transmitted from each of the on-vehicle terminals 4 via the electric communication line 16, and manages the collected data 18. Further, the data server 10 receives a data transmission request 19 from the demander terminal 12 via the electric communication line 16. The data transmission request 19 is data for requesting the data server 10 to transmit a prescribed set of the collected data 18. When receiving the data transmission request 19, the data server 10 transmits the collected data 18 requested by the data transmission request 19, to the demander terminal 12 via the electric communication line 16. When transmitting the data, the data server 10 transmits the encrypted collected data 18 that is decryptable with use of a prescribed decryption key 15. Accordingly, even if the demander terminal 12 acquires the collected data 18 from the data server 10, the collected data 18 cannot be decrypted unless the demander terminal 12 acquires the decryption key 15.

The ID management terminal 11 is a communication terminal communicatively connected to the electric communication line 16, and manages the user terminal 7 and the demander terminal 12. Further, the ID management terminal 11 manages the decryption key 15 for decryption of the collected data 18 which is transmitted from the data server 10. Moreover, the ID management terminal 11 transmits the decryption key 15 to the demander terminal 12 on the basis of a provision permission/non-permission reply 70 received from the user terminal 7. The provision permission/non-permission reply 70 is data indicating whether or not the user U permits data provision a demander.

Each of the demander terminals 12 is a communication terminal with which a demander who uses the collected data 18 for various purposes, receives distribution of the data via the electric communication line 16. A general computer (so-called a PC) provided with a user operation input device (e.g., a keyboard or a touch panel display), a display device, and a communication device that can be communicatively connected to the electric communication line 16, is used as the demander terminal 12. The demander is a company or organization that provides a service related to the car 2, for example. Examples of the demander include a manufacturer of the car 2, a store of the car 2, and a car maintenance company.

In addition, when the demander uses the collected data 18 in the data server 10, an inquiry message 71 for inquiring about permission/non-permission for data provision is transmitted from the demander terminal 12 to the user U of the on-vehicle terminal 4 having transmitted the collected data 18. As a reply in response to the inquiry message 71, the provision permission/non-permission reply 70 is transmitted from the user terminal 7 to the ID management terminal 11.

Next, the configurations of components of the car data management system 1 will be described in detail.

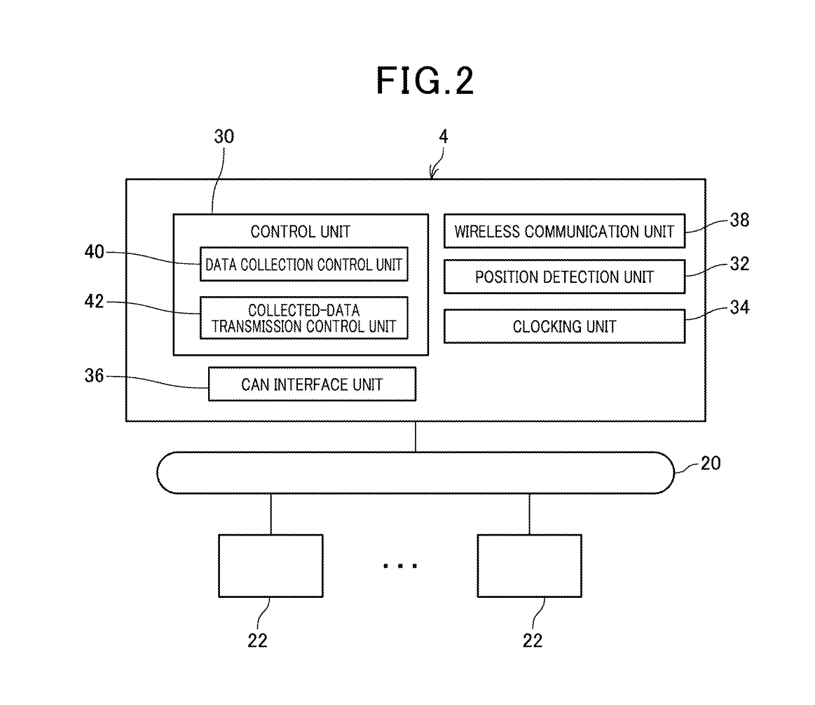

FIG. 2 is a diagram schematically illustrating the configuration of an on-vehicle system provided to the car 2, together with the functional configuration of the on-vehicle terminal 4.

The on-vehicle system includes a CAN (controller area network) 20, a plurality of electronic control units 22, and the on-vehicle terminal 4.

The CAN 20 is one example of a car network (also referred to as an on-vehicle network). The electronic control units 22 and the on-vehicle terminal 4 are connected to the CAN 20. The electronic control units 22 and the on-vehicle terminal 4 perform communication in accordance with a CAN communication protocol.

Each of the electronic control units 22 is an electronic circuit unit which is a so-called “ECU”. Examples of the electronic control units 22 provided in the car 2 include an electronic circuit unit for controlling operation of a power train including an engine, an electronic circuit unit for controlling a transmission, and an electronic circuit unit for controlling an electric component. Examples of the electric component include a wiper, a door lock, a room light, a blinker, and a tail lamp.

Unique identification information is allocated to each of the electronic control units 22. By using the identification information, the on-vehicle terminal 4 can communicate with each of the electronic control units 22.

The on-vehicle terminal 4 includes a control unit 30, a position detection unit 32, a clocking unit 34, a CAN interface unit 36, and a wireless communication unit 38.

The control unit 30 includes a processor such as a CPU or an MPU, and a memory device such as a RAM or a ROM. By operation of the processor in accordance with a prescribed computer program, the control unit 30 controls the components of the on-vehicle terminal 4.

The position detection unit 32 includes a positioning device such as a GPS, and detects the current position (information about the longitude and latitude).

The clocking unit 34 includes a clocking circuit, and clocks the current time, and the date and dime.

The CAN interface unit 36 is an interface for connection to the CAN 20.

The wireless communication unit 38 includes a wireless communication device that performs communication through wireless connection to the electric communication line 16.

Further, by executing the computer program, the control unit 30 implements the function of a data collection control unit 40 and the function of a collected-data transmission control unit 42.

The data collection control unit 40 collects various data from the car 2, by communicating with the electronic control units 22 via the CAN interface unit 36, and acquiring data from the electronic control units 22. The collected data is stored in a memory device provided to the control unit 30, or in a storage device (disk drive such as an HDD or an SSD) provided to the on-vehicle terminal 4.

An on-to-off time period of an ignition key of the car 2 is defined as a unit of 1 drive, and the data collection control unit 40 generates the collected data 18 from collected data by unit of 1 drive. The collected data 18 includes data at an arbitrary timing during 1 drive time period. Examples of such data include a traveling time, a traveling distance, fuel efficiency, the location and the date and time of an ignition-on, the location and the date and time of an ignition-off, a failure code for determining the occurrence of a failure in the car 2, lighting of a warning lamp, car state information about several seconds before and after the occurrence timing of a failure code or a lighting timing of the warning lamp, and a car type. The car state information indicates the state of the car 2, and is various information that can be acquired from the electronic control units 22. When the car 2 is an electric automobile or a hybrid automobile, the collected data 18 also includes electric power consumption in accordance with traveling, the remaining electrical amount in a battery, and the like.

Information in the collected data 18 is obtained directly from data of the position detection unit 32, the clocking unit 34, and the electronic control units 22, or is obtained by analysis and processing of such data by the data collection control unit 40. For example, at an off timing at which the ignition key is turned off, 1-drive collected data 18 is generated by the data collection control unit 40, and is stored in a memory device, etc. Since the collected data 18 is generated on a 1-drive basis, the on/off cycle number of the ignition key during a certain time period can also be specified on the basis of the generated number of sets of the collected data 18 during the certain time period.

In addition to the aforementioned information, the data collection control unit 40 may collect arbitrary information.

When other on-vehicle devices such as navigation devices each having a position detector, or the electronic control units 22 are connected to the CAN 20, the data collection control unit 40 may acquire the current position from the on-vehicle devices or the electronic control units 22.

At a predetermined transmission timing, the collected-data transmission control unit 42 reads out the collected data 18 from the memory device, etc., and transmits the collected data 18 to the data server 10 through communication performed by the wireless communication unit 38. The collected data 18 is recorded as 1 drive-based data, as described above. All the sets of the collected data 18 in an untransmitted state are transmitted at the transmission time of the collected data 18. The transmission timing is arbitrarily defined. At a specific timing such as the on-timing or off-timing of the ignition key, or at an arbitrary timing at which the on-vehicle terminal 4 is operable, the collected data 18 is transmitted.

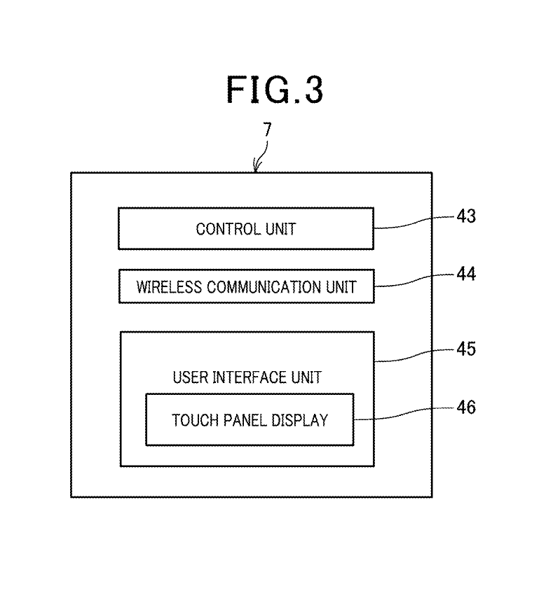

FIG. 3 is a diagram illustrating the functional configuration of the user terminal 7.

The user terminal 7 includes a control unit 43, a wireless communication unit 44, and a user interface unit 45.

The control unit 43 includes a processor such as a CPU or an MPU, and a memory device such as a RAM or a ROM. By operation of the processor in accordance with a prescribed computer program, the control unit 43 controls the components of the user terminal 7. Further, by executing an application program, the control unit 43 provides various application services to the user U. Examples of the application services include an e-mail sending/receiving service, an SNS (social networking service) service, and a push-distribution message receiving service.

The wireless communication unit 44 includes a wireless communication device that performs communication by wireless connection to the electric communication line 16.

The user interface unit 45 has a function as an input device through which a user's operation can be inputted, and a function as a GUI (graphical user interface) display device which displays various operation screens, messages, or the like. The user interface unit 45 includes a touch panel display 46.

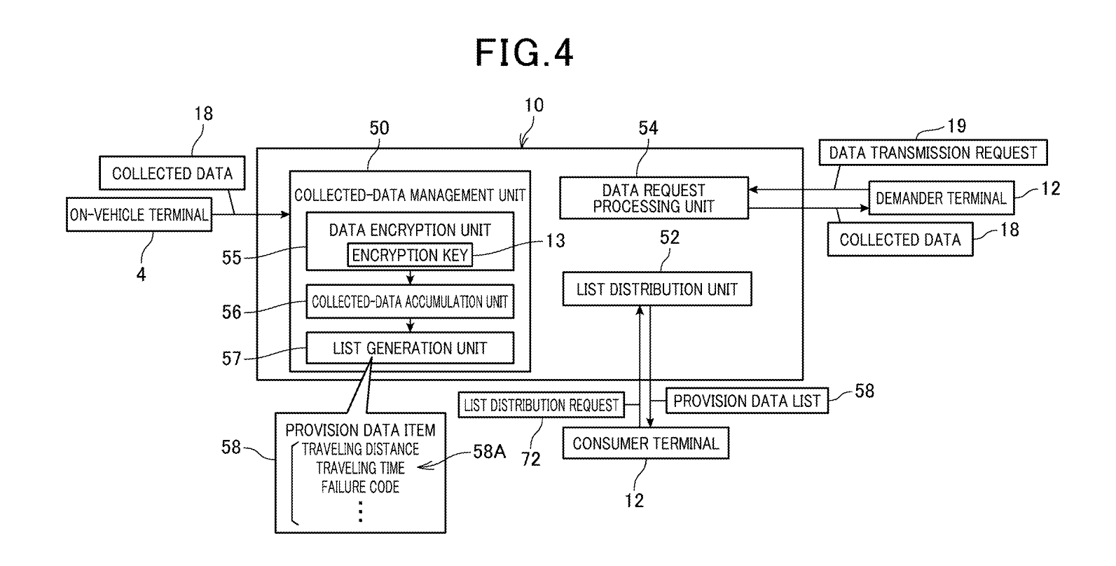

FIG. 4 is a block diagram illustrating the functional configuration of the data server 10.

The data server 10 includes a collected-data management unit 50, a list distribution unit 52, and a data request processing unit 54.

A server computer provided with a processor such as a CPU or an MPU, a memory device such as a ROM or a RAM, a data storage device such as an HDD or an SSD, and a communication device connectable to the electric communication line 16, is used as the data server 10. The processor executes a software program stored in a memory device so that the functions illustrated in FIG. 4 are implemented. The functions of the data server 10 may be implemented by a plurality of server computers.

The collected-data management unit 50 manages the collected data 18 received from each of the on-vehicle terminals 4 by a communication device, and includes a data encryption unit 55, a collected-data accumulation unit 56, and a list generation unit 57.

The data encryption unit 55 encrypts the collected data 18 on per data item 58A basis, by using an encryption key 13 (“public key” of a public key system, in the present embodiment) in accordance with a public key system or a common key system (public key system, in the present embodiment,). The data item 58A is information indicating an item of data which is provided to a demander. All or some data items included in the collected data 18 are the data items 58A. The data items 58A may include a data item obtained by analyzing data included in the collected data 18. Such analysis can be performed, as appropriate, by the data server 10 or another arbitrary computer.

To perform encryption, the data encryption unit 55 uses the encryption key 13 different for each user U and for each data item 58A. The decryption key 15 (“secret key” of the public key system, in the present embodiment) for decryption of encrypted data of the data item 58A is managed by the ID management terminal 11.

The collected-data accumulation unit 56 accumulates, in a data storage device, the collected data 18 encrypted by the data encryption unit 55. The list generation unit 57 generates a provision data list 58 on the basis of the data item 58A of the encrypted collected data 18. The provision data list 58 shows a list of the data items 58A which are provided to a demander.

When receiving a list distribution request 72 from the demander terminal 12, the list distribution unit 52 distributes the provision data list 58 to the demander terminal 12 through the communication device. The demander can get to know what data is available on the basis of the provision data list 58. The provision data list 58 may be distributed by push distribution.

When receiving the data transmission request 19 from the demander terminal 12, the data request processing unit 54 distributes the collected data 18, in the encrypted state, requested by the data transmission request 19 such that the demander can acquire the collected data 18 by using the demander terminal 12. The distribution form of data is arbitrarily defined. Examples of the distribution form include transmission by an e-mail, transferring using an FTP, downloading from a predetermined web site, and uploading to a cloud storage associated with the demander.

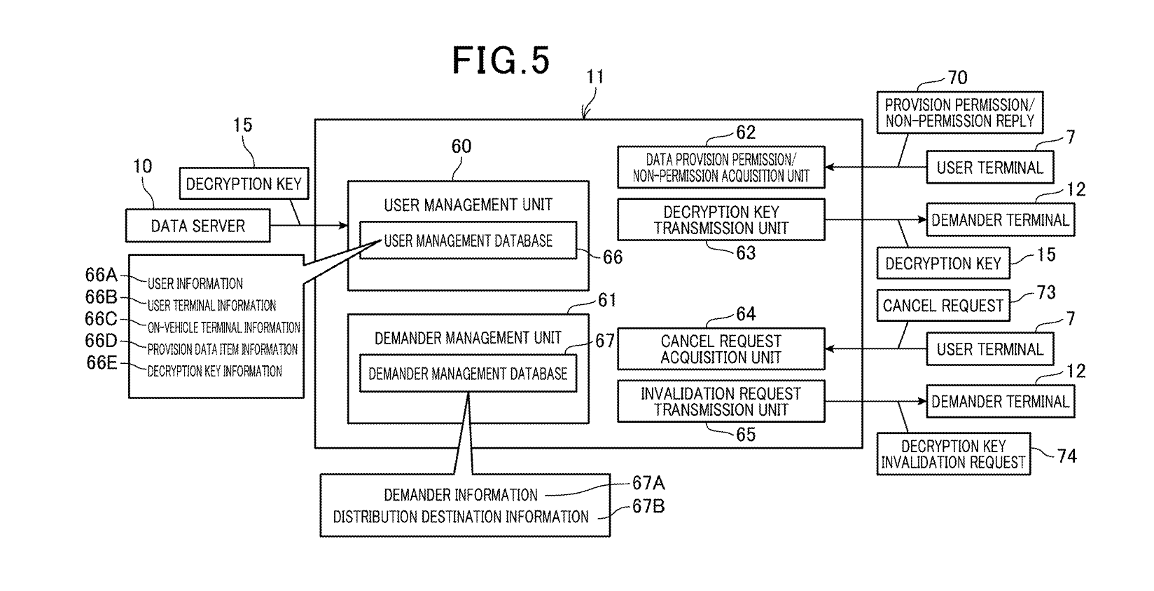

FIG. 5 is a diagram illustrating the functional configuration of the ID management terminal 11.

The ID management terminal 11 includes a user management unit 60, a demander management unit 61, a data provision permission/non-permission acquisition unit 62, a decryption key transmission unit 63, a cancel request acquisition unit 64, and an invalidation request transmission unit 65.

A computer provided with a processor such as a CPU or an MPU, a memory device such as a ROM or a RAM, a data storage device such as an HDD or an SSD, and a communication device connectable to the electric communication line 16, is used as the ID management terminal 11. The processor executes a software program stored in the memory device so that the functions illustrated in FIG. 5 are implemented.

The user management unit 60 manages information concerning the user U on the basis of a user management database 66. The user management database 66 is data stored in a data storage device. User information 66A, user terminal information 66B, on-vehicle terminal information 66C, provision data item information 66D, and decryption key information 66E are stored in association in the user management database 66.

The user information 66A is various information (e.g., the name, the age, and the sex) about the user U. The user terminal information 66B is various information about the user terminal 7. The on-vehicle terminal information 66C is various information about the on-vehicle terminal 4. Either the user information 66A or the user terminal information 66B includes address information based on which the user U can acquire a message or the like through the electric communication line 16 by operating the user terminal 7.

The provision data item information 66D is information, of the collected data 18 received from the on-vehicle terminal 4, indicating the data item 58A to be provided to the demander.

The decryption key information 66E is information about the decryption key 15 for decryption of data of the data items 58A.

The demander management unit 61 manages various information concerning the demander on the basis of a demander management database 67. The demander management database 67 is data base for managing demander information 67A and distribution destination information 67B in association, and is stored in the data storage device.

The demander information 67A includes various information (the name, contact information, and the like) about the demander. The distribution destination information 67B is information indicating a data distribution destination of the collected data 18 accumulated in the data server 10. As described above, a data distribution method is arbitrarily defined as long as the demander can acquire the data by using the demander terminal 12. An address as a transmission destination of data is included in the distribution destination information on the basis of the distribution method.

The data provision permission/non-permission acquisition unit 62 acquires a provision permission/non-permission reply 70 from the user terminal 7 via the electric communication line 16. The provision permission/non-permission reply 70 is data indicating whether or not the user U permits provision of data of the predetermined data item 58A to the demander specified by the user U.

When the user U permits data provision of the predetermined data item 58A, the decryption key transmission unit 63 transmits the corresponding decryption key 15 for the permitted data item 58A to the demander terminal 12.

Consequently, the demander decrypts the collected data 18 separately acquired from the data server 10 by operating the demander terminal 12 with use of the decryption key 15, and thereby, comes to be able to use the data of the corresponding data item 58A permitted by the user U.

The cancel request acquisition unit 64 acquires a cancel request 73 from the user terminal 7 via the electric communication line 16. The cancel request 73 is data for requesting to cancel the permission for all or some of the data items 58A having been permitted to the demander specified by the user U.

When data provision to the demander for whom data provision has been permitted by the user U is inconvenient to the user U for a certain reason, or when the user U has permitted the provision by mistake, the user U can request to cancel the permission on per data item 58A basis, by transmitting the cancel request 73 through the user terminal 7.

The user terminal 7 has installed therein an application program for facilitating transmission operation of the cancel request 73 to be performed by the user U.

For example, the application program is a computer program for causing the user terminal 7 to execute a function of storing the history of the inquiry message 71 received by the user terminal 7 in the past and the history of the provision permission/non-permission reply 70 in response to the inquiry message 71, a function of displaying the demander and the data item 58A for which data provision is permitted by the user U, a function of allowing the user U to select the demander and the data item 58A for which permission is to be cancelled, and a function of transmitting the cancel request 73 for the demander and the data item 58A selected as a cancel target to the ID management terminal 11.

When the cancel request 73 is acquired by the cancel request acquisition unit 64, the invalidation request transmission unit 65 transmits a decryption key invalidation request 74 to the demander terminal 12 specified by the cancel request 73. The decryption key invalidation request 74 is data for requesting the demander terminal 12 to delete or invalidate the decryption key 15 for the data item 58A for which cancel of the permission is requested through the cancel request 73 by the user U. The demander terminal 12 deletes or invalidates the already acquired decryption key 15 on the basis of the decryption key invalidation request 74, so that decryption is impossible afterwards. Accordingly, the demander specified by the user U cannot acquire data from the user U on per data item 58A basis.

In order to ensure the secrecy of the decryption key 15 at the demander terminal 12, the demander terminal 12 has installed therein a dedicated application program for executing decryption using the decryption key 15. In the demander terminal 12, a program other than the dedicated application program is stored so as to be unable to execute reading, copying, and transfer of the decryption key 15.

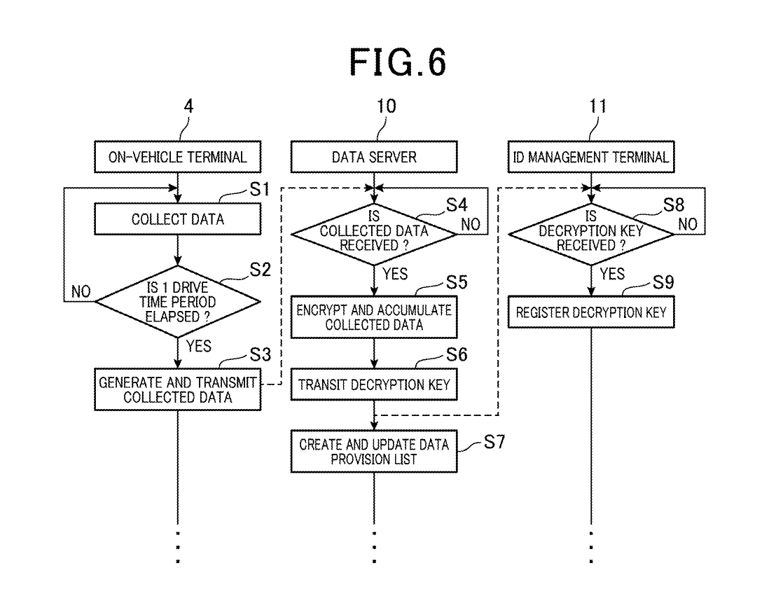

FIG. 6 is a sequence diagram showing operation of the car data management system 1 during data collection of car data.

It is assumed that various information about the user U and the demander is already registered in the user management database 66 and the demander management database 67 of the ID management terminal 11.

The on-vehicle terminal 4 collects various data from the electronic control units 22 connected to the CAN 20 (step S1). The data collecting operation is continuously performed at least during the on time of the ignition key of the car 2. Thereafter, when the 1 drive time period is ended by turning off of the ignition key (step S2: YES), the on-vehicle terminal 4 generates the collected data 18 by combing the data collected during a 1-drive time period into one set, and transmits the collected data 18 to the data server 10 (step S3).

As described above, the collected data 18 includes information about the car 2 (a failure code, the lighting history of a warning lamp, the car state information, etc.). Such information is automatically collected, is transmitted to the data server 10, and is accumulated in the data server 10. When the collected data 18 becomes available to the demander, the demander can efficiently get to know the current state of the car 2 or can efficiently analyze the cause of occurrence of a failure, on the basis of the collected data 18.

When the data server 10 receives the collected data 18 from the on-vehicle terminal 4 (step S4: YES), the collected-data management unit 50 encrypts the collected data 18 with use of the encryption key 13 different for each data item 58A, and accumulates the encrypted collected data 18 (step S5). Thereafter, the data server 10 transmits, to the ID management terminal 11, the decryption key 15 for decryption of the corresponding encrypted data item 58A (step S6). Further, the data server 10 generates the provision data list 58 on the basis of the data item 58A of the collected data 18 (step S7). In step S7, when the provision data list 58 has already existed, the data server 10 updates the existing provision data list 58, if necessary.

Meanwhile, when the ID management terminal 11 receives the decryption key 15 from the data server 10 (step S8: YES), the user management unit 60 registers the decryption key 15 for the data item 58A, in association with the user U, in the user management database 66 (step S9).

As a result of the above process, in the on-vehicle terminal 4, the 1 drive-based collected data 18 is collected, and the collected data 18 is encrypted, and is accumulated in the data server 10. Also, the decryption key 15 necessary for decryption of the collected data 18 is managed by the ID management terminal 11.

When the data item 58A of the collected data 18 received in step S4 is the same as the data item 58A received in past and encryption thereof has been already performed, the data server 10 performs, in step S5, encryption with the encryption key 13 used in the past. In this case, since the decryption key 15 therefor has been transmitted to the ID management terminal 11 by the past encryption, the process in step S6 is unnecessary.

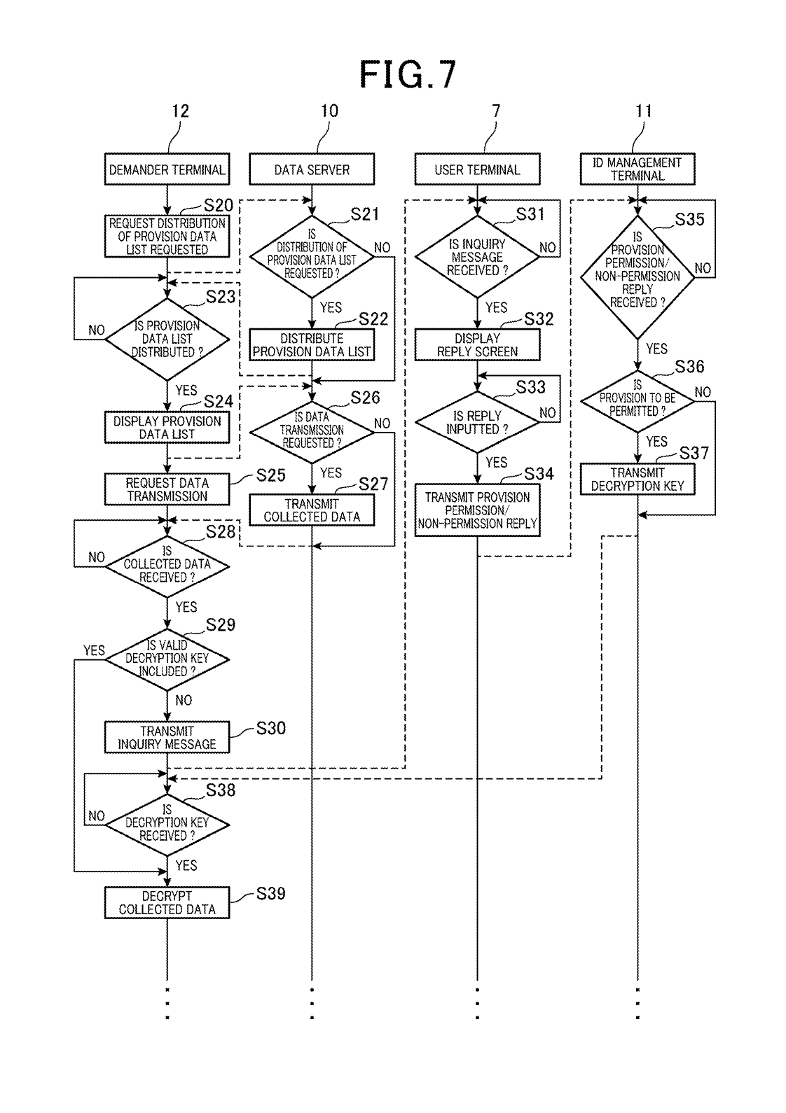

FIG. 7 is a sequence diagram showing operation of the car data management system 1 when the demander uses the collected data 18.

The demander who is trying to know what data is available, transmits, to the data server 10, the list distribution request 72 to request the provision data list 58 by operating the demander terminal 12 (step S20). When the data server 10 receives the list distribution request 72 (step S21: YES), the list distribution unit 52 distributes the provision data list 58 generated by the list generation unit 57 (step S22). The distribution form is arbitrarily defined as long as the demander can acquire and browse the provision data list 58 by operating the demander terminal 12.

When the provision data list 58 is distributed (step S23: YES), the demander receives the provision data list 58 by operating the demander terminal 12 such that the provision data list 58 is displayed on the display device of the demander terminal 12 (step S24).

For example, when the demander does not need to acquire a new provision data list 58 because the provision data list 58 has been already acquired, steps S20 to S24 are omitted. In addition, the data server 10 may perform push-distribution of the latest provision data list 58 to the demander terminal 12 at an appropriate timing, irrespective of the presence/absence of the list distribution request 72.

The demander who desires to use the data of the data item 58A transmits the data transmission request 19 to the data server 10 by operating the demander terminal 12 (step S25).

When the data server 10 receives the data transmission request 19 (step S26: YES), the data server 10 transmits the requested collected data 18 in such a manner that the demander can acquire the collected data 18 by operating the demander terminal 12 (step S27).

Here, data which the demander desires to use can be specified by the data transmission request 19 by unit of the collected data 18 (i.e., by unit of 1 drive). In step S27, the data server 10 transmits the corresponding collected data 18 based on specification by the data transmission request 19. The specification form of the collected data 18 is arbitrarily defined. For example, a form of specifying the collected data 18 collected during a time period specified by a demander (e.g., a cold season, summer, a rainy season, etc.) or collected during traveling in a certain area (e.g., a cold area, a mountainous area, an urban area, a plain area, etc.), a form of specifying the collected data 18 of a specific car type, or a form of specifying the collected data 18 of the user U in a specific age range, can be used.

When receiving the collected data 18 from the data server 10 (step S28: YES), the demander terminal 12 determines whether or not the decryption key 15 valid for decryption of the desired data item 58A of the collected data 18 has been already obtained (step S29). When having already obtained the valid decryption key 15 (step S29: YES), the demander terminal 12 decrypts the collected data 18 by using the decryption key 15, and obtains the data of the desired data item 58A (step S39).

On the other hand, when having not yet obtained the valid decryption key 15 (step S29: NO), the demander terminal 12 transmits the inquiry message 71 in order to obtain permission for data provision from the user U of the on-vehicle terminal 4 having transmitted the collected data 18 (step S30). The inquiry message 71 is transmitted in such a transmission form that the user U can receives the inquiry message 71 by operating the user terminal 7. For example, notification using an e-mail and an SNS message, or using a push message receivable through an application program that is executed by the user terminal 7, can be used for the transmission form.

In step S30, the demander terminal 12 acquires, from the ID management terminal 11, a transmission destination of the inquiry message 71 to the user U. When receiving an inquiry about a transmission destination of the inquiry message 71 from the demander terminal 12, the ID management terminal 11 transmits the transmission destination to the demander terminal 12 by referring to the user information 66A in the user management database 66.

Further, in step S30, when not having obtained the decryption key 15 valid for a plurality of the users U, the demander terminal 12 transmits the inquiry message 71 to each of the users U.

When the user terminal 7 receives the inquiry message 71 (step S31: YES), a reply screen 47 for replying to the inquiry message 71 is displayed on the touch panel display 46 (step S32).

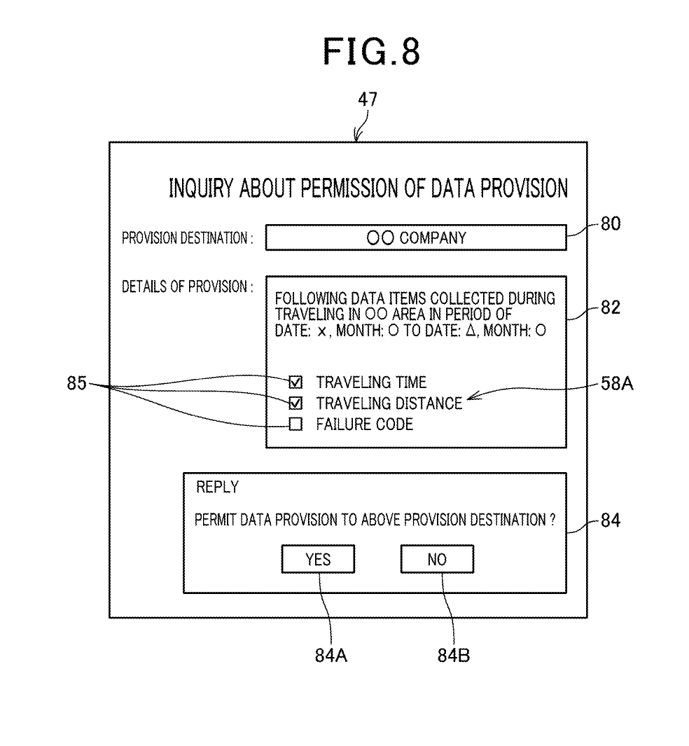

FIG. 8 is a diagram showing one example of the reply screen 47.

A provision destination display area 80, a provision-details display area 82, and a reply area 84 are provided on the reply screen 47.

In the provision destination display area 80, the demander who desires permission for provision of the collected data 18 is displayed. In the provision-details display area 82, one or more of the data items 58A of the collected data 18 which are to be provided to a provision destination (use of which is desired by the demander) are displayed. In the provision-details display area 82, a checkbox 85 for allowing the user U to select the data item 58A provision of which is to be permitted is provided. In the reply area 84, the user U gives a reply about whether or not to agree with data provision, and a “yes” button 84A and a “no” button 84B which can be operated by a user are provided.

The user U gets to know the provision destination of the collected data 18 and the details of provision on the basis of the display on the reply screen 47. To permit the data provision, the user U selects the data item 58A to be permitted by checking the checkbox 85, and operates the “yes” button 84A in the reply area 84. To permit provision of no data, the user U operates the “no” button 84B.

Referring back to FIG. 7, when the user U inputs a reply by performing operation on the reply area 84 (step S33: YES), the user terminal 7 transmits the provision permission/non-permission reply 70 indicative of the details of the reply to the ID management terminal 11 (step S34). When the user U has permitted the data provision, the data provision destination (the demander) and permission information indicating the data item 58A for which data provision has been permitted are stored in the provision permission/non-permission reply 70. When the user U has given no permission for data provision, non-permission information indicating no permission is stored, instead of the permission information.

When the provision permission/non-permission reply 70 from the user terminal 7 is received (step S35: YES), the ID management terminal 11 determines whether or not the permission information is stored in the provision permission/non-permission reply 70 (step S36). When the permission information is stored (step S36: YES), the ID management terminal 11 acquires the decryption key 15 for decryption of the data item 58A by referring to the user management database 66, and transmits the decryption key 15 to the demander terminal 12 of the demander who is the data provision destination (step S37).

On the other hand, when the permission information is not stored (step S36: NO), the ID management terminal 11 does not transmit the decryption key 15. In this case, the ID management terminal 11 may transmit a notification that data provision has not been permitted by the user U, to the demander terminal 12.

When receiving the decryption key 15 from the ID management terminal 11 (step S38: YES), the demander terminal 12 decrypts the collected data 18 received in step S25 by using the decryption key 15 (step S39).

Consequently, the demander becomes able to use the data of the desired data item 58A.

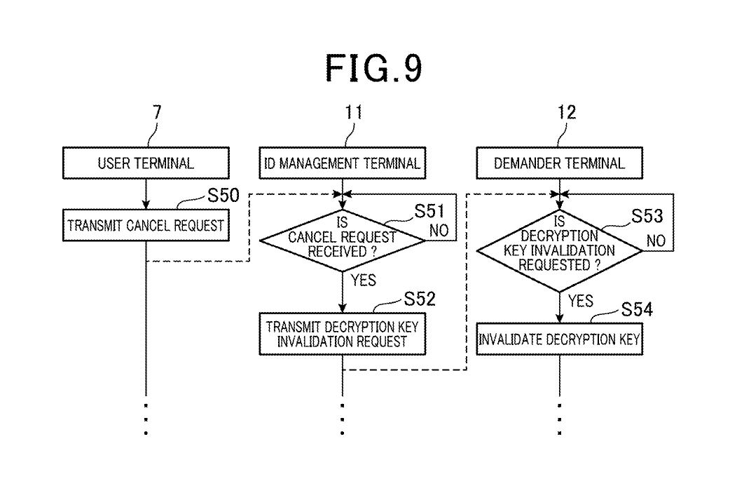

FIG. 9 is a sequence diagram showing operation of the car data management system 1 when provision permission for the data item 58A is canceled by the user U.

To cancel permission for past data provision, the user U transmits the cancel request 73 to the ID management terminal 11 by operating the user terminal 7 (step S50). The cancel request 73 includes the demander (data provision destination) and the data item 58A for which the permission is to be canceled.

When the ID management terminal 11 receives the cancel request 73 (step S51: YES), the ID management terminal 11 transmits the decryption key invalidation request 74 to the demander terminal 12 of the cancel target demander indicated by the cancel request 73 (step S52). The decryption key invalidation request 74 includes information (e.g., information for uniquely specifying the collected data 18) with which the collected data 18 of the user U to be canceled can be identified, and includes the data item 58A of the collected data 18 to be canceled.

When receiving the decryption key invalidation request 74 (step S53: YES), the demander terminal 12 invalidates or deletes the decryption key 15 corresponding to the data item 58A of the collected data 18 indicated by the decryption key invalidation request (step S54).

Consequently, decryption of the data item 58A of the collected data 18 specified by the user U is impossible afterwards.

According to the present embodiment, as described above, the following effects are provided.

In the present embodiment, the decryption key 15 for decryption of the collected data 18 which is transmitted from the data server 10 is managed by the ID management terminal 11, and the demander terminal 12 transmits, to the user terminal 7, the inquiry message 71 for inquiring about permission/non-permission of decryption of the collected data 18 which is transmitted from the data server 10. When permission for decryption is inputted to the user terminal 7 by the operation performed by the user U in response to the inquiry message 71, the ID management terminal 11 transmits the decryption key 15 for decryption of the collected data 18 to the demander terminal 12.

Consequently, a demander who is trying to use the collected data 18 needs to request the permission from the user U, and only a demander permitted by the user U can acquire the decryption key 15, so that the user U can actively provide the collected data 18 to only a demander intended by the user U and the demander can use the collected data 18.

In the present embodiment, the ID management terminal 11 transmits, to the demander terminal 12 that has already received the decryption key 15, the decryption key invalidation request 74 as a signal to request to invalidate or discard the decryption key 15 so as to disable decryption of the collected data 18.

Consequently, even when data provision to the demander to whom data provision was permitted by the user U in the past is inconvenient to the user U, or when the user U has permitted the data provision by mistake, the user U can disable decryption of the collected data 18 at the demander side so as to make the collected data 18 unavailable.

In the present embodiment, the data server 10 includes the list generation unit 57 that generates the provision data list 58 showing the data item 58A included in the collected data 18.

From the provision data list 58, a demander can easily get to know the available data item 58A.

In the present embodiment, the data item 58A included in the collected data 18 is at least one of a time, the on/off cycle number of the ignition key of the car, the fuel efficiency, the power consumption, the remaining electrical amount, the car speed, and the car position information.

Consequently, the demander can acquire data unique to the car 2 from the data server 10, and can use under permission by the user U.

In the present embodiment, the data server 10 provides the decryption key 15 different for each data item 58A of the collected data 18.

Consequently, the user U can arbitrarily give usage permission for each demander by unit of data item 58A included in the collected data 18. Also, the demander side can decrypt the data only by unit of the data item 58A. Therefore, this configuration can ensure higher security, compared to a configuration in which the entire collected data 18 is set to be decryptable with one decryption key 15.

In the present embodiment, the collected data 18 is generated by unit of an on-to-off time period of the ignition key of the car 2.

That is, by unit of a time period from the off to the on of the ignition key, i.e., one drive time period (a riding/driving time period), a data group at an arbitrary timing during the drive time period is combined into one set of the collected data 18.

Consequently, the demander can acquire the collected data 18 by unit of drive time period, and further, can use the data of the desired data item 58A from the arbitrary timing data group collected during the drive time period.

The aforementioned embodiment merely exemplifies one aspect of the present invention. Arbitrary modification or application can be made within the scope of the gist of the present invention.

For example, the on-vehicle terminal 4 may acquire personal information about the user U from the corresponding user terminal 7 possessed by the user U, and include the personal information in the collected data 18. Examples of the personal information about the user U include the sex, the age, information about hobbies and interest. As a method for acquiring the data from the user terminal 7 by means of the on-vehicle terminal 4, an arbitrary method such as cable connection or wireless communication connection can be used.

Since the personal information about the user U is included in the collected data 18, the demander can get to know what type of the user U uses what type of the car 2 for what, on the basis of the collected data 18, and can utilize the collected data 18 in marketing.

In addition, for example, a price for data provision given to the user U by the demander may be included in the inquiry message 71 such that the price is presented on the reply screen 47 to the user U.

Consequently, the demander can become more likely to receive permission for data provision, by presenting, to the user U, a price appropriate for the data item 58A to be provided.

In addition, for example, the on-vehicle terminal 4 may have the function of the user terminal 7. That is, the inquiry message 71 transmitted from the demander terminal 12 is received by the on-vehicle terminal 4. The on-vehicle terminal 4 is provided with an input device through which a user's operation is inputted, and a display device which displays various information. The display device displays the reply screen 47, and the user U inputs a reply through the input device. On the basis of the reply, the on-vehicle terminal 4 transmits the provision permission/non-permission reply 70 to the ID management terminal 11.

In addition, for example, the on-vehicle terminal 4 may have the function of the data encryption unit 55 included in the data server 10, and transmit the collected data 18 having been encrypted by the data encryption unit 55, to the data server 10, and the collected data 18 may be decrypted by the data server 10. In this case, a public key preliminarily acquired from the data server 10 can be used as an encryption key for use in encryption by the on-vehicle terminal 4.

In addition, for example, when another information processing apparatus such as a smartphone or a tablet PC is connected to the on-vehicle terminal 4 in a data communicable manner, the information processing apparatus may have some or all of the functions, of the on-vehicle terminal 4, related to transmission of the collected data (for example, the collected-data transmission control unit 42, and the wireless communication unit 38, etc.).

Similar to the on-vehicle terminal 4, the information processing apparatus has a so-called computer, and is provided with a user operation input device (e.g., a keyboard or a touch panel display), a display device (a liquid crystal panel or an organic EL panel), a processor such as a CPU or an MPU, a memory device such as a RAM or a ROM, a storage device such as an HDD or an SSD, a peripheral-device connecting interface circuit, and a wireless communication device that is wirelessly connected to the electric communication line 16, and the like. In this case, naturally, the information processing apparatus may be the user terminal 7.

For example, a block chain technology may be used in accumulation of the collected data 18 in the data server 10.

Specifically, block chain data in which one set of the collected data 18 is defined as one block is specified for each on-vehicle terminal 4. Each time when the data server 10 receives the collected data 18 from a certain on-vehicle terminal 4, the received collected data 18 is coupled to the terminal end of block chain data from the corresponding on-vehicle terminal 4. By use of the block chain technology in accumulation of the collected data 18, the reliability of each sets of the collected data 18 can be enhanced. Moreover, block chain data of the collected data 18 may be dispersedly stored in a plurality of server computers so that backup of the collected data 18 can be easily performed, and further, the risk of loss can be reduced. Furthermore, each time a new set of the collected data 18 is coupled to block chain data, the validity of the block chain data is confirmed by the plurality of computers. Accordingly, alteration of the collected data is prevented.

In this modification, an encryption key for encryption of one block is equivalent to the encryption key 13, and a decryption key for decryption of the block chain data is equivalent to the decryption key 15. That is, in this modification, the collected data 18 is encrypted in a decryptable manner, with use of the decryption key 15 that is different for each user U.

Additional encryption may be performed with use of the encryption key 13 that is different for each data item 58A of the collected data 18 such that decryption can be performed with use of the decryption key 15 that is different for each data item 58A.

In addition, for example, the data server 10 may have the function of the ID management terminal 11, for example.

The present invention is applicable to arbitrary vehicles such as airplanes, ships, or mobile devices, other than the car 2.

### REFERENCE SIGNS LIST

1 car data management system
2 car (vehicle)
4 on-vehicle terminal (transmission terminal)
7 user terminal
10 data server
11 ID management terminal (management terminal)
12 demander terminal
13 encryption key
15 decryption key
18 collected data (vehicle data)
40 data collection control unit
42 collected-data transmission control unit
45 user interface unit
46 touch panel display
47 reply screen
50 collected-data management unit
52 list distribution unit
54 data request processing unit
55 data encryption unit
56 collected-data accumulation unit
57 list generation unit
58 provision data list
58A data item
60 user management unit
61 demander management unit
62 data provision permission/non-permission acquisition unit
63 decryption key transmission unit
64 cancel request acquisition unit
65 invalidation request transmission unit
66 user management database
67 demander management database

What is claimed is:

1. A vehicle data management system comprising:
a transmission terminal that transmits vehicle data of a vehicle to a data server which transmits data encrypted in a decryptable manner;
a user terminal that can be operated by a user;
a demander terminal that inquires the user terminal about permission/non-permission for decryption of the vehicle data which is transmitted from the data server; and
a management terminal that manages decryption-use data for the vehicle data which is transmitted from the data server, wherein
when permission for decryption in response to the inquiry about permission/non-permission for decryption is inputted to the user terminal through operation performed by the user, the management terminal transmits the decryption-use data for the vehicle data to the demander terminal.

2. The vehicle data management system according to claim 1, wherein
the management terminal includes
a transmission unit that transmits a signal for disabling decryption of the vehicle data to the demander terminal that has already received the decryption-use data for the vehicle data.

3. The vehicle data management system according to claim 1, wherein
the data server includes a list generation unit that generates a list of a data item included in the vehicle data.

4. The vehicle data management system according to claim 1, wherein
the vehicle is a car, and
a data item included in the vehicle data includes at least one of a time, an on/off cycle number of an ignition key of the vehicle, fuel efficiency, power consumption, a remaining electrical amount, a vehicle speed, and vehicle position information.

5. The vehicle data management system according to claim 1, wherein
the data server provides decryption-use data different for each data item of the vehicle data.

6. The vehicle data management system according to claim 1, wherein
the vehicle is a car, and
the vehicle data is generated by unit of on-to-off time period of an ignition key of the vehicle.

7. A vehicle data management method for a vehicle data management system that includes:
a transmission terminal that transmits vehicle data of a vehicle to a data server which transmits data encrypted in a decryptable manner;
a user terminal that can be operated by a user; and
a demander terminal that receives the decryptable vehicle data from the data server,
the method comprising:
a step of causing a management terminal to manage decryption-use data for the vehicle data which is transmitted from the data server;
a step of causing the demander terminal to inquire the user terminal about permission/non-permission for decryption of the vehicle data which is received from the data server; and
a step of, when permission for decryption in response to the inquiry about permission/non-permission for decryption is inputted to the user terminal through operation performed by the user, transmitting the decryption-use data for the vehicle data from the management terminal to the demander terminal.
